(19) United States
(12) Patent Application Publication
(10) Pub. No.: US 2004/0218569 A1
(43) Pub. Date: Nov. 4, 2004

(54) Method and network device for wireless data transmission

(76) Inventors: Klaus Ingemann Pedersen, Aalborg (DK); Preben Mogensen, Gistrup (DK); Jose Outes, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/479,455

(22) PCT Filed: Aug. 14, 2002
(86) PCT No.: PCT/IB02/03270

(51) Int. Cl. H04Q 7/00

(52) U.S. Cl. 370/334

(57) ABSTRACT

The present invention relates to a method and network device for transmitting data through a wireless transmission link using at least two reception beams. A reception beam through which the data has been received is determined and a modulation code for modulating the data is allocated according to the determined reception beam. Thereby, a specific code, e.g. scrambling code, can be assigned to a user equipment (50) depending on the beam it is connected to. Using this strategy for code assignment, own-cell signals received under one reception beam can be orthogonal assuming a synchronized transmission scheme. Signals received under another reception beam using another code will not be orthogonal, but this interference contribution is suppressed by the spatial filtering gain offered by the beamforming antenna system.

### FIELD OF THE INVENTION

The present invention relates to a method and network device for transmitting data through a wireless transmission link, such as a transmission link using an Uplink Synchronized Transmission Scheme (USTS) of a cellular communication network.

### BACKGROUND OF THE INVENTION

USTS is a feature which is proposed for the uplink direction, i.e. terminal device towards radio access network, of a cellular WCDMA (Wideband Code Division Multiple Access) system within the standardization body 3GPP (third generation partnership project). The basic idea is to synchronize the transmission of signals from terminal devices, e.g. user equipments (UEs) or mobile terminals, in the same cell, so that the signals are time-aligned when they arrive at a node B. The node B corresponds to a base station device in a Universal Mobile Telecommunication System (UMTS). The advantage of USTS is that orthogonal codes can be applied for user separation of UEs within the cell, so that own-cell interference is eliminated. The same principle is applied for the downlink direction of UMTS, where orthogonal channelisation codes which may be derived from a set of Walsh codes are used for own cell user separation. Further details of USTS can be gathered from the 3GPP specifications TR 25.839 and TR 25.854.

In CDMA systems, a concept of spreading the information is used, wherein user information bits a spread over a wide bandwidth by multiplying user data with quasi-random bits, called chips, derived from CDMA spreading codes. In order to support very high bit rates, the use of a variable spreading factor and multicode connections is supported. Spreading is applied to the physical channels. It consists of two operations. The first operation is a channelisation operation, which transforms every data symbol into a number of chips, thus increasing the bandwidth of the signal. The number of chips per data symbol is called the spreading factor. The second operation is a scrambling operation, where a scrambling code is applied to the spread signal. Scrambling is used on top of spreading to thereby separate terminals or base stations from each other. It does not change the signal bandwidth but only makes the signals from different sources separable from each other. With the scrambling feature, it does not matter if the actual spreading were done with identical code for several transmitters. Further details regarding the spreading and scrambling feature are defined in the 3GPP specification TS 25.213.

Without USTS, each UE uses a unique scrambling code for transmission and orthogonal channelisation codes for separating of parallel channels transmitted from the same UE. However, for USTS all UEs in the same cell are using a common scrambling code and the channels transmitted from each UE will be separated by using different channelisation codes. This imposes certain constrains on the maximum number of UEs per cell, since the set of available channelisation codes is rather limited. This basically means that with USTS, the maximum number of UEs becomes limited to a substantial degree. This poses a severe problem for the uplink direction, since each UE occupies at least two channelisation codes, i.e. one for the dedicated physical control channel (DPCCH) and one for the dedicated physical data channel (DPDCH). In the downlink direction, transmission towards one UE only requires one channalization code.

In order to circumvent this problem, the above 3GPP specification TR 25.854 allows the assignment of multiple scrambling codes to UEs within the same cell. This increases the number of available code resources per cell due to the fact that each scrambling code is associated with a channelisation code tree. However, this introduction of multiple scrambling codes within a cell leads to the drawback that the signals transmitted under different scrambling codes are non-orthogonal. This basically means that introduction of more than one scrambling code tends to reduce the potential interference gain achieved by USTS. In particular, the potential gain from introducing USTS is limited by the finite amount of channelisation code resources under one scrambling code. Introducing additional scrambling codes mitigates the code shortage problem, but at the same time increases blocking on the air interface due to the absence of orthogonality of signals transmitted under different scrambling codes.

### SUMMARY OF THE INVENTION

It is therefore an object of the present invention to provide a wireless transmission scheme by means of which the number of available code resources can be increased while maintaining the interference gain.

This object is achieved by a method of transmitting data through a wireless transmission link, said method comprising the steps of: using at least two reception beams for providing said transmission link; determining a reception beam through which said data has been received; and allocating a modulation code for modulating said data, according to said determined reception beam.

Furthermore, the above object is achieved by a network device for controlling a wireless transmission link comprising at least two reception beams, said network device comprising: receiving means for receiving an information indicating a reception beam through which data has been received from said transmission link; and allocating means for allocating a modulation code for modulating said data, according to said indicated reception beam.

Additionally, the above object is achieved by a network device for providing a wireless transmission link, said network device comprising: beamforming means for generating at least two reception beams for said wireless transmission link; determination means for determining a reception beam through which data has been received from said transmission link; and allocating means for allocating a modulation code for modulating said data, according to said determined reception beam.

Accordingly, the same modulation code is assigned to all UEs from which data has been received under the same reception beam. Signals received under another reception beam using another modulation code will not be orthogonal, but this interference contribution is suppressed by the spatial filtering gain offered by the at least two reception beams. The cost of allowing multiple scrambling codes in a cell is thereby reduced, so that the gain of the synchronized transmission can be maintained and becomes less sensitive to code shortage.

The modulation code may be a scrambling code or any other code based on which transmission sources can be distinguished.

Furthermore, the transmission link may be an uplink transmission link in an uplink synchronized transmission scheme. In this case, orthogonal channelisation codes may be allocated to each wireless transmission link. The determination step may then be performed based on a measurement of an uplink received power. This power may relate to a beam dependent pilot signal.

The information received by the receiving means and indicating the receiving reception beam may be a cell portion index. This cell portion index may be received in radio resource control message, e.g. a connection request message.

Furthermore, the information indicating the receiving reception beam may be an uplink power measurement report.

The beamforming means may be a fixed beam antenna array for generating at least two fixed beams.

The network device may be a base station device or a radio network controller device.

Advantageous further developments are defined in the dependent claims.

### BRIEF DESCRIPTION OF THE DRAWINGS

The present invention will now be described on the basis of preferred embodiments with reference to the accompanying drawings in which:

FIG. 1 shows a schematic block diagram of a cellular network system according to the preferred embodiments;

FIG. 2 shows a schematic signalling and processing diagram indicating a call setup procedure according to the first preferred embodiment; and

FIG. 3 shows a signalling and processing diagram of a beam handover operation according to the first preferred embodiment.

### DESCRIPTION OF THE PREFERRED EMBODIMENTS

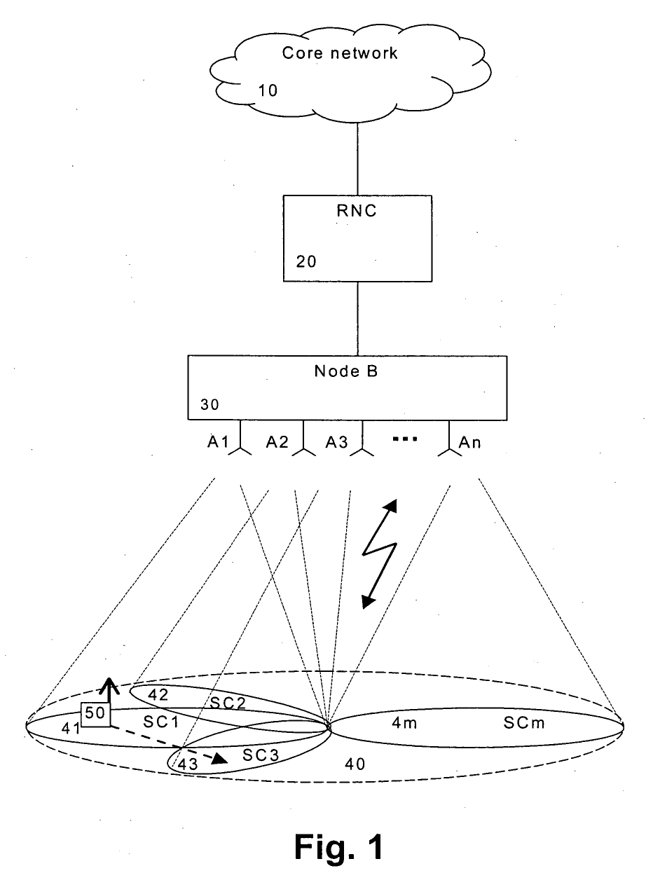

The preferred embodiments will now be described on the basis of a cellular WCDMA system using an USTS feature, as shown in FIG. 1.

According to FIG. 1, a WCDMA radio access network (RAN), e.g. a UMTS Terrestrial RAN (UTRAN), comprising at least one node B 30 and at least one RNC 20 is connected to a core network 10 which may be a GSM (Global System for Mobile communication) based core network and/or a UMTS based core network. Functionally, the RAN network elements handle all radio-related functionality, and the core network 10 is responsible for switching and routing calls and data connections to external networks. A UE 50 interfaces with a user and the radio interface of the RAN. The node B 30 converts the data flow and participates in radio resource management. The RNC 20 owns and controls the radio resources in its domain, e.g. the node Bs connected to it. It is the service access point for all services which the RAN provides to the core network 10, for example management of connections to the UE 50.

According to the preferred embodiments, the node B 30 comprises a plurality of beamforming antennas A1 to An. Thereby, a finite set of fixed beams can be formed at the node B 30, so that each beam covers a narrow azimuthal area defining a cell portion 41 to 4m of a controlled cell area 40.

According to the preferred embodiments, the antennas A1 to An may be arranged as a uniform linear array in which the inter-antenna spacing is in the order of one half of a carrier wavelength. The cell portions 41 to 4m are covered with narrow beams having an increased antenna gain compared to a conventional sector antenna. Thus, the array of the antennas A1 to An are used to form several portions within a cell with controlled radiation patterns. Each of the cell portions 41 to 4m are covered by a specific beam antenna radiation pattern which can be created e.g. by applying a specific weight vector on the beamforming antenna or using a grid of fixed beam directions.

The beamforming capability of the node B 30 is required to be known by the RNC 20. To achieve this, average wideband power measurements can be reported from the node B 30 to the RNC 20 over the respective lub interface. Thus, a measurement message can be sent for each cell portion 41 to 4m in addition to the sector wideband measurement. The reporting of these measurements can be on request or periodic, as specified for sector wideband measurements. Furthermore, an information can be added to a node B configuration message, so that the RNC 20 obtains information on the number of beams in which the node B 30 conducts wideband power measurements for radio resource management (RRM) purposes. The specific beamforming measurements are intended for RRM purposes such as admission control (AC), packet scheduling (PS) etc. During a random access procedure, the RNC 20 is informed about the cell portion in which the new UE, e.g. the UE 50, is located. This information is required in order to be able to make a decision on whether the UE 50 can get a call accepted. The cell portion of the UE 50 is equivalent to the portion of the uplink where the highest signal-to-interference ratio (SIR) is received from that particular UE 50. This can be accomplished by introducing a new procedure during random access e.g. before deciding on admission, in which the RNC 20 asks the node B 30 to perform a best cell portion measurement. Alternatively, this could be accomplished by adding a cell portion index to each random access message sent from the node B 30 to the RNC 20. Similar action can be taken during soft handover (SHO) where the RNC 20 needs information of which cell portion the UE 50 belongs to. This information is needed in the AC in order to decide for available resources before the new radio link is created. This can be accomplished e.g. by asking the node B 30 to perform a best cell portion measurement before deciding if the new link should be created.

Furthermore, a pilot signal or channel can be assigned per beam. For this particular case, the UE 50 transition from one beam to another requires higher layer signailing, since the UE 50 needs to get informed that it should use another pilot channel. To be able to handle this, the node B 30 may be adapted to measure the uplink received power of the pilot symbols for each UE in all reception beams where a pilot channel is assigned. This measurements can be locally averaged in the node B 30 before they are reported to the RNC 20. The length of the power averaging window can be selected by the RNC 20. Based on these measurements, the RNC 20 then determines whether a beam handover is needed or not.

The problem of reduced USTS interference gain by using more than one scrambling code can be mitigated by providing the node B 30 with the beamforming antennas A1 to An. In this case, the cell portion covered by each beam can be isolated from the cell portions covered by other beams, although there may be some overlap between neighbouring beams due to side-lobes, etc. Now, a specific scrambling code can be assigned to the UE 50 depending on the beam to which it is connected. Thus, the same scrambling code is assigned to all UEs connected by the same reception beam. Thereby, additional robustness is added to USTS, such that the interference gain becomes less sensitive to code shortage problems. The scrambling code assignment to UEs is thus based on the beam by which the respective UE is connected. The functionality for scrambling code assignment or allocation can be implemented either in the RNC 20 or in the node B 30.

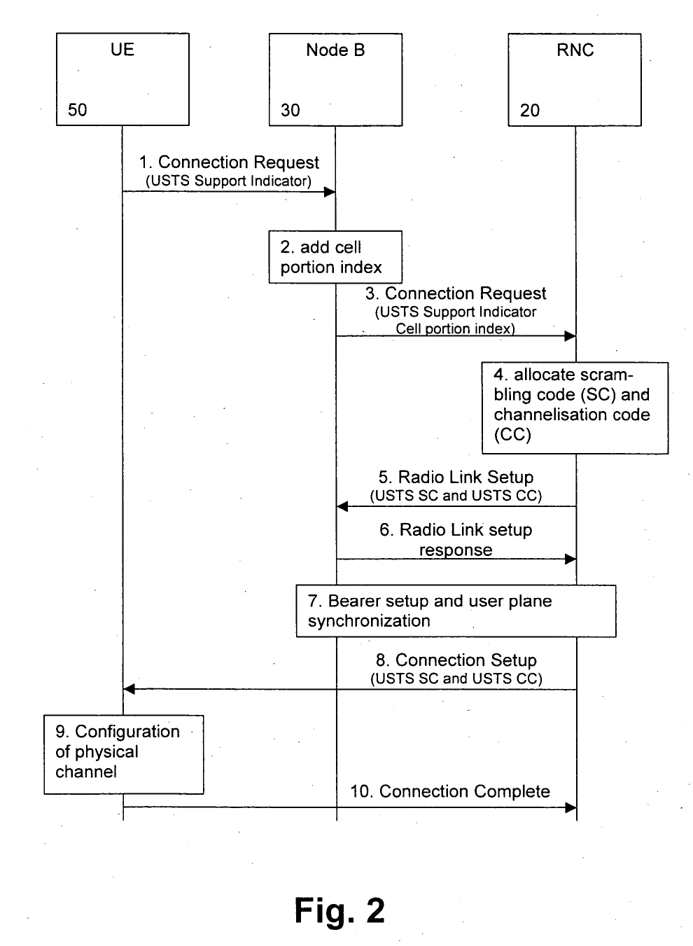

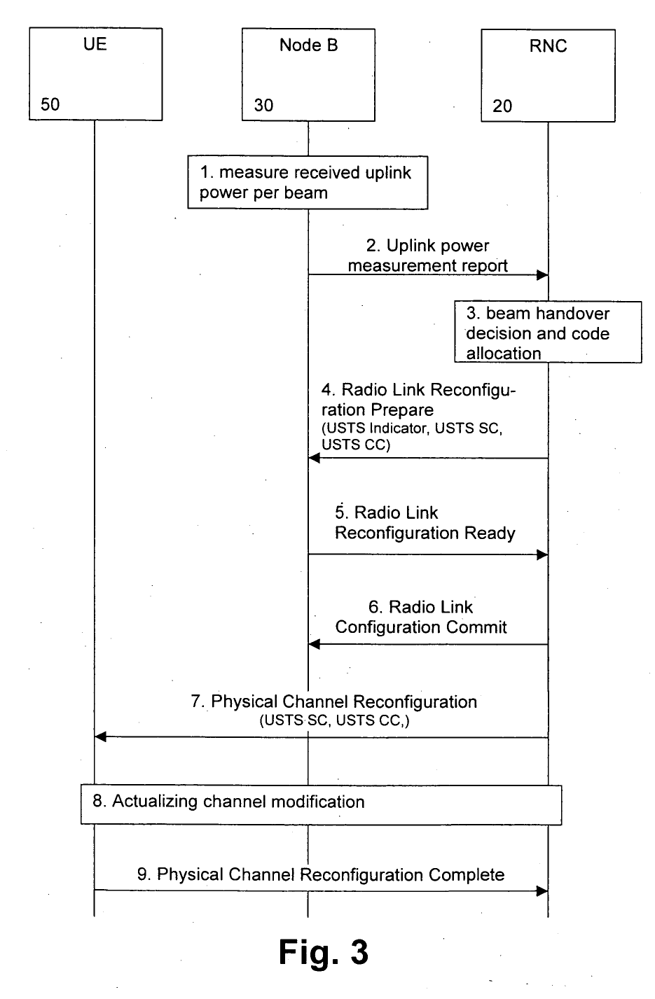

In the following, signalling and processing examples for scrambling code allocation at the RNC 20, according to a first preferred embodiment, are described on the basis of the signalling and processing diagrams shown in FIGS. 2 and 3.

FIG. 2 shows a signalling and processing diagram indicating a USTS call setup procedure. In step 1, the UE 50 sends a connection request, e.g. a radio resource control (RRC) Connection Request message, via the node B 30 to the serving RNC 20. This request comprises a USTS support indicator by means of which the UE 50 indicates that it supports the USTS feature. When the node B 30 receives the request directed to the RNC 20, it adds in step 2 a cell portion index indicating the cell portion or beam in which the signal received from the UE 50 has the highest power or SIR value. This termination may be based on the respective uplink power measurements. Then, the node B 30 forwards the connection request with the USTS support indicator and the cell portion index to the RNC 20. At the RNC 20, a scrambling code (SC) and a channelisation code (CC) are allocated to the UE 50. This allocation may be performed in accordance with the 3GPP specification TS 25.213. Then, in step 5, the RNC 20 transmits a radio link setup message, e.g. Radio Link Setup Request, comprising the allocated USTS scrambling code and a USTS channelisation code number. The node B 30 allocates corresponding resources, starts physical channel reception and responds with a response message, e.g. Radio Link Setup Response. The signalling between the node B 30 and the RNC 20 may be a NBAP (Node B Application Part) signalling.

In step 7, the RNC 20 initiates a setup of a corresponding lub data transport bearer and the node B 30 and the RNC 20 establish synchronism for the data transport bearer by means of exchange of appropriate dedicated channel frame protocol frames. In step 8, the RNC 20 sends a connection setup message, e.g. RRC Connection Setup, to the UE 50. This message also includes the allocated USTS scrambling code and USTS channelisation code number. In response thereto, the UE 50 configures the physical channel according to the allocated scrambling code and channelisation code and controls the transmission timing based on a provided initial synchronization timing information. In step 10, the UE 50 responds with a corresponding message, e.g. RRC Connection Complete, to the RNC 20. Thus, a scrambling code SC1 used in the present cell portion 41 of the UE 50 is allocated by the RNC 20 to the UE 50.

In the following, it is assumed that the UE 50 moves within the cell area 40 to a new cell portion 43 to which a new scrambling code SC3 is allocated, as indicated by the broken arrow in FIG. 1. The corresponding beam handover procedure is now described based on the signalling and processing diagram shown in FIG. 3.

According to FIG. 3, the node B 30 is arranged to measure for each UE the received uplink power per beam (step 1). As already mentioned, this measurement may be performed at regular intervals or on request from the RNC 20. In step 2, the node B 30 transmits an uplink power measurement report to the RNC 20. Also this report may be issued at regular intervals or on request from the RNC 20. Based on the received uplink power measurement report, the RNC 20 decides on a beam handover to a new cell portion, e.g. the new cell portion 43 in FIG. 1, with a higher uplink power measurement. If a new cell portion with higher measured uplink power is determined by the RNC 20, a new scrambling code, e.g. the scrambling code SC3 of the new cell portion is allocated to the UE 50. Then, in step 4, the RNC 20 transmits a link configuration message, e.g. Radio Link Reconfiguration Prepare, comprising an USTS indicator, the allocated USTS scrambling code and allocated USTS channelisation code number to the node B 30. The node B 30 responds in step 5 with a radio link reconfiguration response, e.g. Radio Link Reconfiguration Ready.

Then, the RNC 20 transmits a channel reconfiguration message, e.g. RRC Physical Channel Reconfiguration, comprising the allocated USTS scrambling code and USTS channelisation code number to the UE 50. Based on this notification, both the UE 50 and the node B 30 actualise the physical channel parameters by a corresponding channel modification procedure (step 8). Finally, in step 9, the UE 50 sends an acknowledgement, e.g. RRC Physical Channel Reconfiguration Complete to the RNC 20. Thus, the UE 50 now transmits to the node B 30 using the new scrambling code SC3 allocated to the new cell portion 43.

According to a second preferred embodiment, the allocation of the scrambling code may be performed at the node B 30. In this case, the node B 30 determines the scrambling code based on the own uplink power measurements of the UE 50 and selects a scrambling code according to the cell portion from which the highest uplink power or SIR is received. A corresponding relation may be stored in a lookup table provided at the node B 30. Then, the selected scrambling code can be transmitted in the connection request message, e.g. in step 3 in FIG. 2, to the RNC 20 which uses the information to generate the connection setup message forwarded to the UE 50.

Similarly, in the beam handover case, the node B 30 may allocate the scrambling code based on the determined uplink power measurement report and may thus signal the allocated scrambling code together with the uplink power measurement report to the RNC 20, e.g. in step 2 of FIG. 3. Then the RNC 20 uses this information to generate the channel reconfiguration message, e.g. in step 7 of FIG. 3.

It is noted that the present invention is not restricted to the above described preferred embodiments, but may be implemented in any cellular or wireless transmission system where modulation codes are used for transmitting and/or receiving data via a multi-beam antenna arrangement. Furthermore, the signalling between the base station device and the radio network controller device may be based on any protocol suitable to convey a power measurement report and a cell portion index. The provision of the code allocation functionality at the base station device may be implemented without subsequent signalling to the RNC 20, if an IP RAN system is used, in which substantial parts of the RRC functionality are provided at a corresponding IP BTS (Internet Protocol Base Transceiver Station) device. The preferred embodiments may thus vary within the scope of the attached claims.

1. A method of transmitting data through a wireless transmission link, said method comprising the steps of:
a) using at least two reception beams for providing said transmission link;
b) determining a reception beam through which said data has been received; and
c) allocating a modulation code for modulating said data according to said determined reception beam.

2. A method according to claim 1, wherein said modulation code is a scrambling code.

3. A method according to claim 1, wherein said transmission link is an uplink transmission link in an uplink synchronized transmission scheme.

4. A method according to claim 3, further comprising the step of allocating orthogonal channelisation codes to each wireless transmission link.

5. A method according to claim 3, further comprising the step of performing said determination step based on a measurement of an uplink received power.

6. A method according to claim 5, wherein said uplink received power relates to a beam-dependent pilot signal.

7. A network device for controlling a wireless transmission link comprising at least two reception beams, said network device comprising:
a) receiving means for receiving an information indicating a reception beam through which data has been received from said transmission link; and
b) allocating means for allocating a modulation code for modulating said data, according to said indicated reception beam.

8. A network device according to claim 7, wherein said wireless transmission link is a link of an uplink synchronized transmission scheme.

9. A network device according to claim 7, wherein said information is a cell portion index.

10. A network device according to claim 7, wherein said information is an uplink power measurement report.

11. A method according to claim 9, wherein said information is received in a radio resource control message.

12. A network device according to claim 11, wherein said radio resource control message is a connection request.

13. A network device according to claim 7, wherein said modulation code is a scrambling code.

14. A network device according to claim 7, wherein said network device is a radio network controller device.

15. A network device for providing a wireless transmission link, said network device comprising:
a) beamforming means for generating at least two reception beams for said wireless transmission link;
b) determination means for determining a reception beam through which data has been received from said transmission link; and
c) allocating means for allocating a modulation code for modulating said data, according to said determined reception beam.

16. A network device according to claim 15, wherein said beamforming means is a fixed beam antenna array.

17. A network device according to claim 15, wherein said determination means are arranged to determine said reception beam based on an uplink power measurement.

18. A network device according to claim 15, wherein said modulation code is a scrambling code of an uplink synchronized transmission scheme.

19. A network device according to claim 15, wherein said network device is a base station device.
